(19) United States
(12) Patent Application Publication
(10) Pub. No.: US 2012/0299816 A1
(43) Pub. Date: Nov. 29, 2012

(54) HYBRID DISPLAY APPARATUS AND DISPLAY METHOD THEREOF

(75) Inventor: Woo Cheol LEE, Suwon-si (KR)

(73) Assignee: SAMSUNG ELECTRONICS CO. LTD., Suwon-si (KR)

(21) Appl. No.: 13/464,280

(22) Filed: May 4, 2012

(30) Foreign Application Priority Data
May 24, 2011 (KR) 10-2011-0048858

(51) Int. Cl. G09G 3/36; G09G 5/00; G02F 1/1335; G02B 27/14; G02B 5/30; G06F 3/038; G09G 5/10

(52) U.S. Cl. 345/156; 345/204; 345/690; 359/629; 359/483.01; 349/33; 345/88

(57) ABSTRACT

A hybrid display apparatus and a display method thereof are provided. In the apparatus, an emissive type display panel outputs an internal light to the outside and thereby displays data. A reflective type display panel passes the internal light to the outside, reflects an external light, and thereby displays the data. An intermediate film layer is interposed between the emissive type display panel and the reflective type display panel. The intermediate film layer passes the internal light from the emissive type display panel to the reflective type display panel, and also blocks the external light that passes through the reflective type display panel and is reflected at the emissive type display panel.

### PRIORITY

This application claims the benefit under 35 U.S.C.§119(a) of a Korean patent application filed on May 24, 2011 in the Korean Intellectual Property Office and assigned Serial No. 10-2011-0048858, the entire disclosure of which is hereby incorporated by reference.

### BACKGROUND OF THE INVENTION

1. Field of the Invention

The present invention relates to a display technology. More particularly, the present invention relates to a hybrid display apparatus and a display method thereof.

2. Description of the Related Art

Normally, a display apparatus performs a display function using a display panel. Plasma Display Panel (PDP) and Liquid Crystal Display (LCD) are known as representative examples of a display apparatus. The LCD has a backlight and displays data through light generated by the backlight. Meanwhile, a recent display apparatus often uses Organic Light Emitting Diodes (OLEDs) that display data through self-emission. An OLED is formed of self-emissive organic material using electroluminescence phenomenon. Namely, when power is supplied, an OLED generates light by itself and uses such light to display data.

A display apparatus according to the related art has irregular quality of display. Namely, depending on the location of a display apparatus, the display quality may be varied. For instance, when the ambient illumination around a display apparatus is similar to or higher than the illumination of light generated by the display apparatus, this may degrade the visibility of data displayed on the display apparatus.

### SUMMARY OF THE INVENTION

Aspects of the present invention are to address at least the above-mentioned problems and/or disadvantages and to offer at least the advantages described below. Accordingly, an aspect of the present invention is to achieve a regular and reliable quality of display in a display apparatus.

Another aspect of the present invention is to improve the visibility of data displayed on a display apparatus.

In accordance with an aspect of the present invention, a hybrid display apparatus is provided. The apparatus includes an emissive type display panel for outputting an internal light to the outside and for displaying data, a reflective type display panel for passing the internal light to the outside, for reflecting an external light, and for displaying the data, and an intermediate film layer interposed between the emissive type display panel and the reflective type display panel, and for passing the internal light from the emissive type display panel to the reflective type display panel and for blocking the external light that passes through the reflective type display panel and is reflected at the emissive type display panel.

In accordance with another aspect of the present invention, a display method of a hybrid display apparatus is provided. The method includes determining whether to drive each of an emissive type display panel and a reflective type display panel, and displaying the data with an image and color by driving at least one of the emissive type display panel and the reflective type display panel, wherein the hybrid display apparatus includes the emissive type display panel for outputting an internal light to the outside and thereby to display data, the reflective type display panel for passing the internal light to the outside, to reflect an external light, and for displaying the data, and an intermediate film layer, interposed between the emissive type display panel and the reflective type display panel, for passing the internal light from the emissive type display panel to the reflective type display panel and for blocking the external light that passes through the reflective type display panel and reflected at the emissive type display panel.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating an internal configuration of a display apparatus according to an exemplary embodiment of the present invention.

FIG. 2 is a block diagram illustrating an internal configuration of a display unit according to an exemplary embodiment of the present invention.

FIG. 3 is a cross-sectional view illustrating a configuration of a display panel according to an exemplary embodiment of the present invention.

FIG. 4 is a circuit diagram illustrating a circuitry configuration of a switching device part according to an exemplary embodiment of the present invention.

FIG. 5 is a diagram illustrating a display panel operation according to an exemplary embodiment of the present invention.

FIG. 6 is a flowchart illustrating a display method of a display apparatus according to an exemplary embodiment of the present invention.

FIGS. 7 to 17 are views illustrating methods for controlling a display panel of a display apparatus according to exemplary embodiments of the present invention.

Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

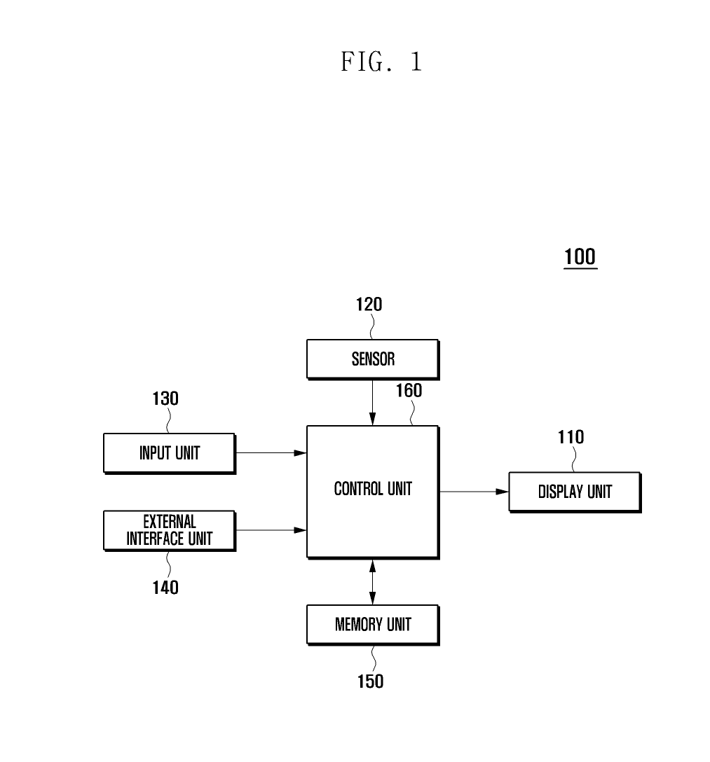

FIG. 1 is a block diagram illustrating an internal configuration of a display apparatus according to an exemplary embodiment of the present invention.

Referring to FIG. 1, the display apparatus 100 includes a display unit 110, a sensor 120, an input unit 130, an external interface unit 140, a memory unit 150, and a control unit 160.

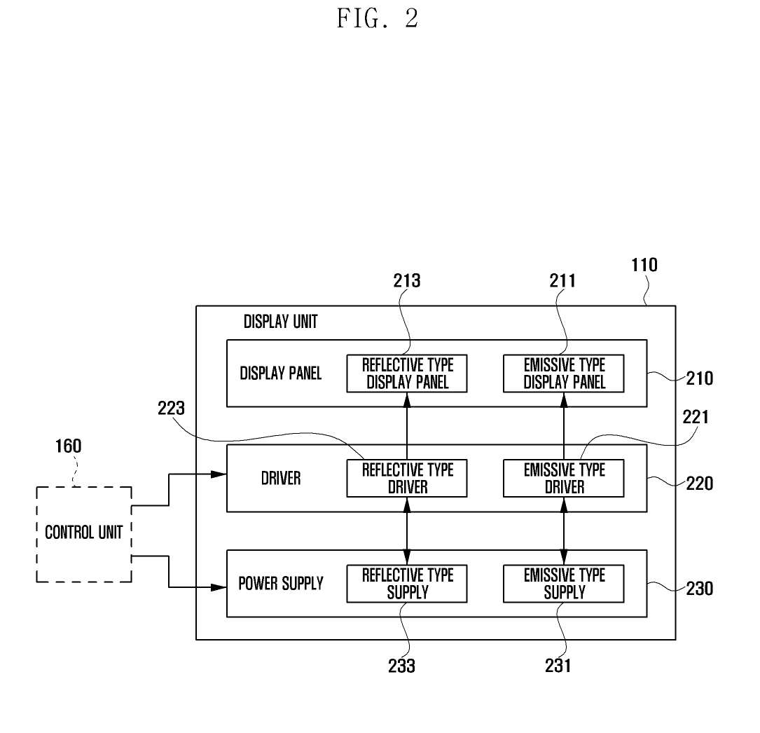

The display unit 110 performs a function to display an image. Namely, the display unit 110 receives data outputted from the control unit 160 and displays it as an image. In an exemplary implementation, the display unit 110 may be implemented in a hybrid form. The display unit 110 will be described in more detail below with reference to FIG. 2.

FIG. 2 is a block diagram illustrating an internal configuration of a display unit according to an exemplary embodiment of the present invention.

Referring to FIG. 2, the display unit 110 includes a display panel 210, a driver 220, and a power supply 230.

The display panel 210 is composed of an emissive type display panel 211 and a reflective type display panel 213. More particularly, the display panel 210 is formed as a stack structure of the emissive type display panel 211 and the reflective type display panel 213. Namely, the reflective type display panel 213 is stacked on the emissive type display panel 211 in the display panel 210. The display panel 210 is driven to display data, depending on operation modes. Namely, in an image display mode, the display panel 210 displays data through at least one of the emissive type display panel 211 and the reflective type display panel 213. More specifically, the emissive type display panel 211 displays data by using internal light. Namely, the emissive type display panel 211 displays data by allowing internal light to be emitted to the outside. Also, the reflective type display panel 213 allows internal light to be emitted to the outside. Namely, when the emissive type display panel 211 displays data, such displayed data is projected on the reflective type display panel 213. Additionally, apart from the emissive type display panel 211, the reflective type display panel 213 displays data by using external light. Namely, the reflective type display panel 213 displays data by reflecting external light.

The driver 220 drives the display panel 210, depending on operation modes of the display apparatus 100, under the control of the control unit 160. Also, the driver 220 separately drives the emissive type display panel 211 and the reflective type display panel 213. For this, the driver 220 is composed of an emissive type driver 221 and a reflective type driver 223. Namely, in an image display mode, the driver 220 drives at least one of the emissive type display panel 211 and the reflective type display panel 213 through at least one of the emissive type driver 221 and the reflective type driver 223. More specifically, the emissive type driver 221 offers data, outputted from the control unit 160, to the emissive type display panel 211. Similarly, the reflective type driver 223 offers data, outputted from the control unit 160, to the reflective type display panel 213. Meanwhile, in the driver 220, the emissive type driver 221 and the reflective type driver 223 may be independently formed to be distinguished from each other or may be united in a single form.

The power supply 230 supplies electric power to the display panel 210, depending on operation modes of the display apparatus 100, under the control of the control unit 160 or the driver 220. The power supply 230 separately supplies power to the emissive type display panel 211 and the reflective type display panel 213. For this, the power supply 230 is composed of an emissive type supply 231 and a reflective type supply 233. Namely, in an image display mode, the power supply 230 supplies power to at least one of the emissive type display panel 211 and the reflective type display panel 213 through at least one of the emissive type supply 231 and the reflective type supply 233. More specifically, the emissive type supply 231 supplies power to the emissive type display panel 211 through the emissive type driver 221, and the reflective type supply 233 supplies power to the reflective type display panel 213 through the reflective type driver 223. Meanwhile, in the power supply 230, the emissive type supply 231 and the reflective type supply 233 may be independently formed to be distinguished from each other or may be united in a single form.

Returning to FIG. 1, the sensor 120 performs a function to detect ambient illumination around the display apparatus 100. Namely, the sensor 120 measures the illumination at a place where the display apparatus 100 is located. The sensor 120 may be a light sensor such as an optical sensor or a proxy sensor. Meanwhile, the sensor 120 may be organized in a module form within the display apparatus 100.

The input unit 130 creates a command for controlling operation modes of the display apparatus 100. That is, the input unit 130 creates, depending on a user's manipulation, a command for controlling whether to drive the display apparatus 100. The input unit 130 may have well known input devices such as at least one key or touch panel.

The external interface unit 140 performs a function to interact with any other external device (not illustrated). More particularly, the external interface unit 140 may receive display data from another device. In addition, the external interface unit 140 may perform communication through a wired manner such as a Universal Serial Bus (USB) or through a wireless manner such as Bluetooth, an Ultra WideBand (UWB), a Near Field Communication (NFC), and the like. Meanwhile, the external interface unit 140 may be connected to any other device through an image input manner such as a High Definition Multimedia Interface (HDMI), a D-Subminiature (D-SUB), and the like.

The memory unit 150 may be composed of a program memory and a data memory. The program memory stores various programs for controlling general operations of the display apparatus 100. More particularly, in exemplary embodiments of this invention, the program memory may store programs for controlling the display unit 110 according to the ambient illumination. The data memory stores data produced while such programs are executed. More particularly, in an exemplary implementation, the data memory may store reference data used to determine, depending on the ambient illumination, whether to drive the reflective type display panel 213 or whether to drive the emissive type display panel 211. The reference data may be at least one critical value for classifying the ambient illumination.

The control unit 160 performs a function to control operations of the display apparatus 100. The control unit 160 determines whether to drive the display unit 110 according to the operation mode of the display apparatus 100. Namely, in an image display mode, the control unit 160 drives the display unit 110 to display data. For this, the control unit 160 may have an image processing device and thereby create data to be displayed. Additionally, the control unit 160 may receive such data from other device through the external interface unit 140. More particularly, the control unit 160 determines, depending on the ambient illumination, whether to drive the reflective type display panel 213 or whether to drive the emissive type display panel 211. Also, the control unit 160 drives at least one of the emissive type display panel 211 and the reflective type display panel 213 by using the driver 220 and the power supply 230. Thereby, the control unit 160 allows at least one of the emissive type display panel 211 and the reflective type display panel 213 to display data.

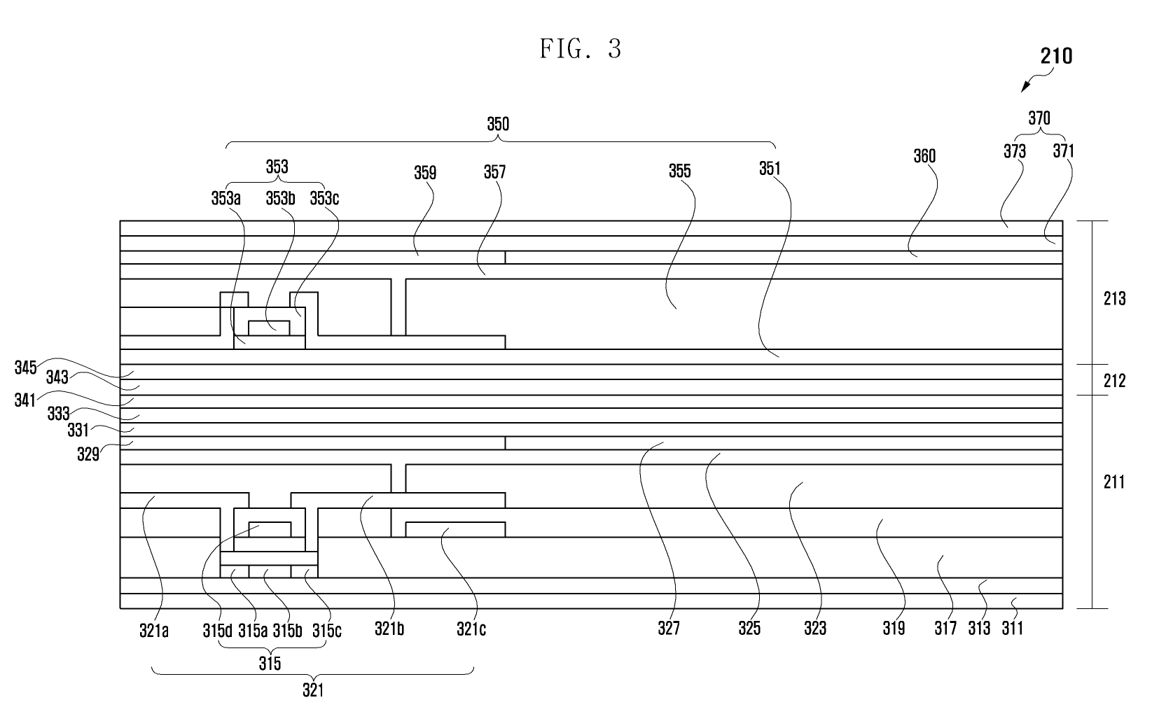

FIG. 3 is a cross-sectional view illustrating a configuration of a display panel according to an exemplary embodiment of the present invention.

Referring to FIG. 3, the display panel 210 has a stack structure in which the reflective type display panel 213 is stacked on the emissive type display panel 211. Additionally, in the display panel 210, an intermediate film layer 212 may be interposed between the emissive type display panel 211 and the reflective type display panel 213. Although the emissive type display panel 211 may be formed of an OLED as discussed hereinafter, this is exemplary only and it should be understood that it is not limited thereto.

The emissive type display panel 211 includes a base substrate 311, a buffer layer 313, a driving semiconductor layer 315, a gate dielectric layer 317, an interlayer dielectric layer 319, a switching device part 321, a planarization layer 323, a pixel electrode 325, an organic light-emitting layer 327, a pixel definition layer 329, a common electrode 331, and a permeable layer 333.

The base substrate 311 serves as a support in the emissive type display panel 211. The base substrate 311 may be formed of flexible material. Also, the base substrate 311 may be formed of insulating material such as glass, quartz, ceramic or plastic. Also, the base substrate 311 may be formed of stainless steel.

The buffer layer 313 is disposed on the base substrate 311. The buffer layer 313 may be formed of one of silicon nitride, silicon oxide, and silicon oxynitride.

The driving semiconductor layer 315 is disposed on the buffer layer 313. The driving semiconductor layer 315 may be formed of polysilicon, i.e., polycrystalline silicon. More particularly, the driving semiconductor layer 315 is composed of a source region 315a, a channel region 315b, and a drain region 315c. The channel region 315b may be formed without dopants. The source and drain regions 315a and 315c may be doped with p-type dopants such as B₂H₆, for example, which may be varied according to the kind of Thin Film Transistor (TFT).

The gate dielectric layer 317 is disposed on a gate line of the driving semiconductor layer 315. The interlayer dielectric layer 319 is formed to cover a gate electrode 315d. The gate dielectric layer 317 and the interlayer dielectric layer 319 may be formed of silicon nitride or silicon oxide.

The switching device part 321 is disposed on the driving semiconductor layer 315. The switching device part 321 may be a TFT having a source electrode 321a, a drain electrode 321b, and a capacitor 321c. Also, the switching device part 321 may be an active matrix electrode composed of two TFTs and one capacitor.

The planarization layer 323 is formed on the interlayer dielectric layer 319 and covers the source electrode 321a, the drain electrode 321b, and the capacitor 321c. The planarization layer 323 compensates for an uneven surface in order to enhance luminous efficiency of the emissive type display panel 211. The planarization layer 323 may be formed of acrylic resin or polyamide resin. Also, the planarization layer 323 may have contact holes for a connection between the drain electrode 321b and the pixel electrode 325.

The pixel electrode 325 is disposed on the planarization layer 323. The pixel electrode 325 produces an electric potential difference with the common electrode 331, so the organic light-emitting layer 327 emits light. The pixel electrode 325 is electrically connected to the drain electrode 321b through the contact holes formed in the planarization layer 323. The pixel electrode 325 may be one of a transmissive type, a transflective type, and a reflective type.

The organic light-emitting layer 327 is disposed on the pixel electrode 325, separately from the pixel definition layer 329. The organic light-emitting layer 327 may be formed of low-molecular organic material or high-molecular organic material. In addition, the organic light-emitting layer 327 has a multi-layered structure composed of a hole injection layer, a hole transport layer, a light-emitting layer, an electron transport layer, and an electron injection layer. More specifically, the hole injection layer may be formed on the pixel electrode 325, and the hole transport layer, the light-emitting layer, the electron transport layer and the electron injection layer may be stacked thereon one by one. Therefore, the electron injection layer may adhere closely to the bottom of the common electrode 331.

The pixel definition layer 329 is disposed on the pixel electrode 325. More particularly, the pixel definition layer 329 absorbs external light and thereby suppresses the reflection of external light. For this, the pixel definition layer 329 may be formed in black or gray color or may be colorless. Also, the pixel definition layer 329 may be formed of polyacrylic or polyamide resin and pigment.

The common electrode 331 is disposed on the organic light-emitting layer 327 and the pixel definition layer 329. The common electrode 331 may be one of transmissive type, transflective type, and reflective type.

The permeable layer 333 is disposed on the common electrode 331. The permeable layer 333 may be formed of organic or inorganic material. More particularly, the permeable layer 333 may have suitable thickness and refractive index such that the reflection of light may cause effective destructive interference.

Meanwhile, the intermediate film layer 212 is stacked on the emissive type display panel 211 and composed of the first phase delay film 341, a polarizer film 343, and the second phase delay film 345.

The first phase delay film 341 is disposed on the emissive type display panel 211. The first phase delay film 341 may be a quarter-wavelength film.

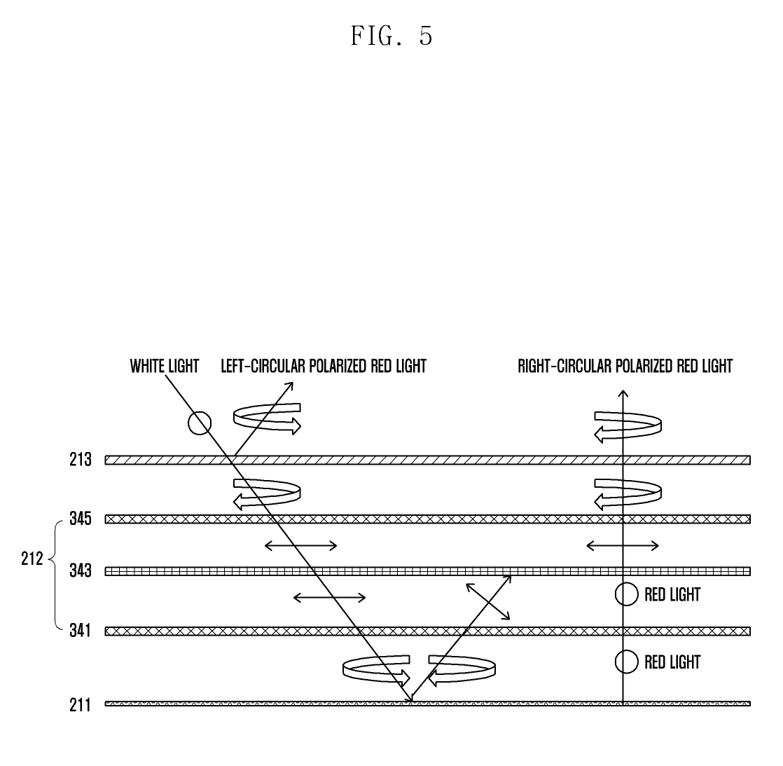

The polarizer film 343 is disposed on the first phase delay film 341. The polarizer film 343 only passes a specific polarized light among white light and absorbs or blocks others. An angle of intersection between an optic axis of the first phase delay film 341 and a polarization axis of the polarizer film 343 may range from −50 to −40 degrees. The polarizer film 343 and the first phase delay film 341 may convert a linear polarized light into a circular polarized light, which is described in more detail below with reference to FIG. 5.

The second phase delay film 345 is disposed on the polarizer film 343. The second phase delay film 345 may be a quarter-wavelength film. An angle of intersection between an optic axis of the second phase delay film 345 and a polarization axis of the polarizer film 343 may range from 40 to 50 degrees.

Meanwhile, the reflective type display panel 213 is stacked on the intermediate film layer 212 and includes the first substrate 350, the second substrate 370, and a liquid crystal layer 360 interposed between the first and second substrates 350 and 370.

The first substrate 350 is disposed on the intermediate film layer 212 and may be divided into a plurality of unit pixel regions that are formed of a gate and a data line. The first substrate 350 has a base substrate 351, a switching device part 353, an interlayer dielectric layer 355, a pixel electrode 357, and a pixel definition layer 359.

The base substrate 351 serves as a support in the first substrate 350. The base substrate 351 may be formed of flexible material. Also, the base substrate 351 may be formed of insulating material such as glass, quartz, ceramic or plastic.

The switching device part 353 is disposed on the base substrate 351. The switching device part 353 may be a TFT having a source electrode 353a, a gate electrode 353b, and a drain electrode 353c. Also, the switching device part 353 may be an active matrix electrode composed of two TFTs and one capacitor.

The interlayer dielectric layer 355 is disposed on the base substrate 351 and the switching device part 353. The interlayer dielectric layer 355 may be formed of inorganic material such as silicon oxide or silicon nitride or may be formed of organic material.

The pixel electrode 357 is disposed on the interlayer dielectric layer 355. The pixel electrode 357 is formed in each unit pixel region and is a transparent electrode made of transparent conductive material such as Indium Tin Oxide (ITO), Indium Zinc Oxide (IZO), Aluminum doped Zinc Oxide (AZO), and the like. In order to obtain the pixel electrode 357, the transparent conductive material is deposited with a thickness of about 0.02 μm to about 0.5 μm on the interlayer dielectric layer 355 and patterned through a photo etching process.

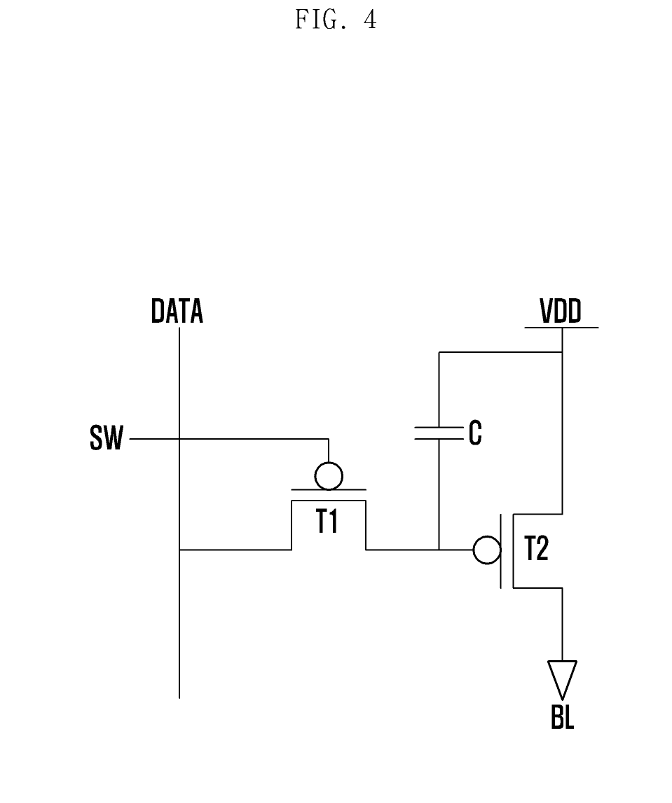

The pixel electrode 357 is electrically connected to the switching device part 353 through contact holes formed in the interlayer dielectric layer 355. When the switching device part 353 is turned on, a pixel voltage is applied to the pixel electrode 357 through the drain electrode 353c of the switching device part 353. Now, an exemplary process for applying a pixel voltage to the pixel electrode 357 through the switching device part 353 will be described in more detail below with reference to FIG. 4.

FIG. 4 is a circuit diagram illustrating a circuitry configuration of a switching device part according to an exemplary embodiment of the present invention. Although the switching device part may be an active matrix electrode as discussed hereinafter, this is exemplary only and it should be understood that it is not limited thereto.

Referring to FIG. 4, the switching device part 353 is composed of the first driving transistor T1, the second driving transistor T2, and a storage capacitor C. The first driving transistor T1 delivers a data voltage of a data line DATA to the second driving transistor T2, depending on a switching voltage applied through a switching line SW. The storage capacitor C is connected to both the first driving transistor T1 and a power line VDD and stores a voltage corresponding to a difference between a voltage received from the first driving transistor T1 and a voltage supplied to the power line VDD. The second driving transistor T2 is connected to both the power line VDD and the storage capacitor C and supplies an output current to the pixel electrode 357 in proportion to the square of a difference between a voltage stored in the storage capacitor C and a critical voltage.

Returning to FIG. 3, the pixel definition layer 359 is disposed on the pixel electrode 357. More particularly, the pixel definition layer 359 absorbs external light and thereby suppresses the reflection of external light. For this, the pixel definition layer 359 may be formed in black or gray color or may be colorless. Also, the pixel definition layer 359 may be formed of polyacrylic or polyamide resin and pigment.

Although not illustrated in the drawings, the first substrate 350 may further have an alignment layer formed on the pixel electrode 357. The alignment layer pre-tilts liquid crystal molecules of the liquid crystal layer 360.

The second substrate 370 is disposed on the first substrate 350, while covering the liquid crystal layer 360. The second substrate 370 may be divided into a plurality of unit pixel regions that are formed of a gate and a data line. The second substrate 370 has a common electrode 371 and a base substrate 373.

Like the pixel electrode 357, the common electrode 371 is a transparent electrode made of transparent conductive material such as ITO, IZO, AZO, and the like.

The base substrate 373 is disposed on the common electrode 371 and serves as a support in the second substrate 370. The base substrate 373 may be formed of flexible material. Also, the base substrate 373 may be formed of insulating material such as glass, quartz, ceramic or plastic.

When a pixel voltage is applied to the pixel electrode 357 of the first substrate 350 and a common voltage is applied to the common electrode 371 of the second substrate 370, an electric field is produced in the liquid crystal layer 360 between the first and second substrates 350 and 370.

The liquid crystal layer 360 is formed of liquid crystal molecules. Such liquid crystal molecules may be coated on the first substrate 350 by means of an ink jet technique or may be injected into a space between the first and second substrates 350 and 370 by means of a capillary action. More particularly, the liquid crystal layer 360 may be formed of Cholesteric Liquid Crystal (CLC), but not limited thereto. Alternatively, the liquid crystal layer 360 may be formed of any other various kinds of reflective type liquid crystal molecules.

As well known in the art, CLC has a helical structure in which chiral dopant is added to a host having a nematic phase. Therefore, CLC has optical properties such as rotator polarization, selective light scattering, circular polarization, and dichroism. Also, CLC reflects incident light with a specific wavelength, depending on a helical pitch which is varied according to chiral dopant concentration. Through this, CLC may reflect one of a red light, a green light, and a blue light.

Additionally, CLC may be classified into levorotatory twisted CLC and dextrorotatory twisted CLC, based on helical twist direction. Levorotatory twisted CLC has an anticlockwise rotation structure, thus passing a left-circular polarized light and reflecting a right-circular polarized light with a specific wavelength band. Dextrorotatory twisted CLC has a clockwise rotation structure, thus passing a right-circular polarized light and reflecting a left-circular polarized light with a specific wavelength band. Namely, the liquid crystal layer 360 may be formed of at least one of levorotatory twisted CLC and dextrorotatory twisted CLC. More particularly, the liquid crystal layer 360 may be spatially divided through partitions such that levorotatory twisted CLC and dextrorotatory twisted CLC are alternatively disposed.

Furthermore, CLC is changed to one of a planar state, a focal conic state, and a homeotropic state, depending on the strength of an electric field applied thereto, so the reflectance of CLC is varied. In the planar state, a helical axis of CLC is arranged in a vertical direction to the first substrate 350, and the reflectance of CLC is about 30%. In the focal conic state, a helical axis of CLC is arranged in a horizontal direction with the first substrate 350, and the reflectance of CLC is about 3˜4%. In the homeotropic state, a helical axis of CLC is arranged in a direction of electric field, and the reflectance of CLC is about 0.5˜0.75%. When no voltage is applied, CLC is changed to the planar state. When a certain voltage is applied in the planar state, CLC is changed to the focal conic state. When a relatively greater voltage is applied in the focal conic state, CLC is changed to the homeotropic state.

Meanwhile, although not illustrated, the common electrode 331 or the pixel electrode 325 of the emissive type display panel 211 may be electrically connected to the pixel electrode 357 of the reflective type display panel 213. Also, the common electrode 331 of the emissive type display panel 211 may be electrically connected to the common electrode 371 of the reflective type display panel 213. In such case, the switching device part 353 may be omitted from the reflective type display panel 213.

FIG. 5 is a diagram illustrating the operation of a display panel according to an exemplary embodiment of the present invention. FIG. 5 will be focused on a pixel cell that corresponds to a unit pixel region in the display panel and exhibits a specific color. Here, it is assumed that the pixel cell exhibits a red color.

Referring to FIG. 5, a white light falls on the reflective type display panel 213. Here, the white light contains a plurality of wavelengths and phases. When the white light falls, the reflective type display panel 213 reflects a circular polarized light corresponding to a red spectrum, that is, a circular polarized red light. Namely, CLC in the reflective type display panel 213 reflects a circular polarized red light in the white light due to its inherent properties such as rotator polarization, selective light scattering, circular polarization, and dichroism. If dextrorotatory twisted CLC is used in the reflective type display panel 213, the reflective type display panel 213 reflects a left-circular polarized red light in the white light and passes a right-circular polarized light in the white light. Therefore, a left-circular polarized red light reflected in the reflective type display panel 213 is displayed.

Similarly, if levorotatory twisted CLC is used in the reflective type display panel 213, the reflective type display panel 213 reflects a right-circular polarized light in the white light and passes a left-circular polarized light in the white light.

A right-circular polarized light passing through the reflective type display panel 213 enters into the second phase delay film 345. The second phase delay film 345 converts a right-circular polarized light into a linear polarized light. Here, the linear polarized light agrees with a polarization axis of the polarizer film 343 and may pass through the polarizer film 343. If an angle of intersection between the second phase delay film 345 and the polarizer film 343 is in a range from 40 to 50 degrees, preferably 45 degree, a right-circular polarized light falling on the second phase delay film 345 may be converted into a linear polarized light agreeing with a polarization axis of the polarizer film 343. Additionally, the linear polarized light that is converted by the second phase delay film 345 and passes through the polarizer film 343 enters into the first phase delay film 341. The first phase delay film 341 converts the linear polarized light into a left-circular polarized light. Here, the first phase delay film 341 has an angle of intersection with the polarizer film 343 being in a range from −50 to −40 degrees, preferably −45 degree.

Additionally, a left-circular polarized light converted by the first phase delay film 341 falls on the emissive type display panel 211. The emissive type display panel 211 reflects a left-circular polarized light into a right-circular polarized light. Also, the right-circular polarized light reflected by the emissive type display panel 211 enters into the first phase delay film 341. The first phase delay film 341 converts the right-circular polarized light into a linear polarized light. Here, the linear polarized light does not agree with a polarization axis of the polarizer film 343. Therefore, the polarizer film 343 fails to pass the linear polarized light that is converted by the first phase delay film 341. Namely, the linear polarized light is blocked at the polarizer film 343.

Meanwhile, although not illustrated, a linear polarized light converted by the second phase delay film 345 may run vertically to a polarization axis of the polarizer film 343, so it may not pass the polarizer film 343 and disappear. The polarizer film 343 of absorptive type may absorb and remove a linear polarized light that fails to agree with a polarization axis of the polarizer film 343.

Therefore, the display panel 210 reflects a left-circular polarized red light in a white light such that the reflected red light may is displayed. Also, the display panel 210 prevents a white light, except a left-circular polarized red light, from is displayed. Namely, the display panel 210 can express a particular color by reflecting an external incident light at the reflective type display panel 213. This allows the user of the display apparatus 100 to perceive an image through the reflective type display panel 213 at any place with a relatively higher ambient illumination, e.g., outdoors in the daytime, without any secondary light source.

Meanwhile, the emissive type display panel 211 produces and outputs a red light from an internal light. This red light enters into the first phase delay film 341. The first phase delay film 341 passes an incident red light. The red light passing through the first phase delay film 341 falls on the polarizer film 343. The polarizer film 343 converts an incident red light into a linear polarized red light. The linear polarized red light falls on the second phase delay film 345. The second phase delay film 345 converts a linear polarized red light into a right-circular polarized red light. Unlike the first phase delay film 341, an optic axis of the second phase delay film 345 has an intersection angle of 40 to 50 degrees with a polarization axis of the polarizer film 343. Therefore, a linear polarized light is converted into a right-circular polarized light at the second phase delay film 345. Additionally, a right-circular polarized red light converted by the second phase delay film 345 falls on the reflective type display panel 213. The reflective type display panel 213 passes a right-circular polarized red light to the outside.

Therefore, the display panel 210 produces a right-circular polarized red light such that the produced red light is displayed. Namely, the display panel 210 can express a particular color by producing an internal light at the emissive type display panel 211. This allows a user of the display apparatus 100 to perceive an image through the emissive type display panel 211 at any place with a relatively lower ambient illumination, e.g., outdoors at nighttime or indoors, without any secondary light source or external light.

Accordingly, the display apparatus 100 according to an exemplary embodiment of the present invention allows a user to perceive an image regardless of ambient illumination. In other words, the display apparatus 100 may achieve a regular and reliable quality of display regardless of its location. Also, the display apparatus 100 may improve the visibility of data displayed thereon.

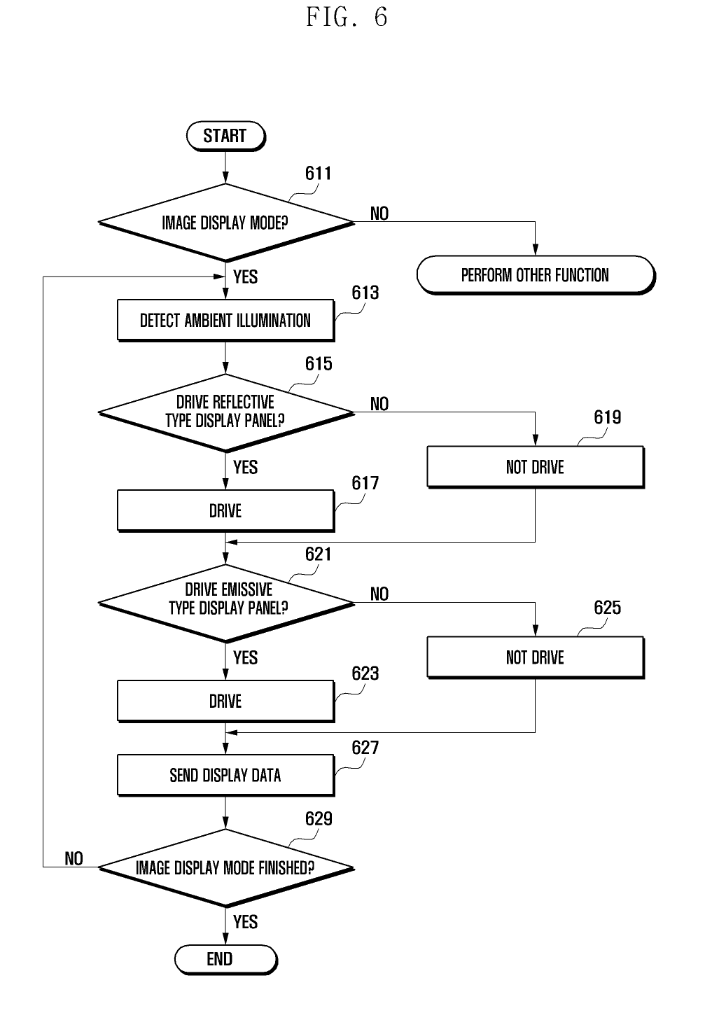

FIG. 6 is a flowchart illustrating a display method of a display apparatus according to an exemplary embodiment of the present invention.

Referring to FIG. 6, the control unit 160 recognizes the operation mode of the display apparatus 100 in step 611. More specifically, when receiving a command to drive the display apparatus 100 through the input unit 130, the control unit 160 may drive the display apparatus 100 and enter into an image display mode. After recognizing an image display mode in step 611, the control unit 160 detects ambient illumination through the sensor 120 in step 613. Namely, using the sensor unit 120, the control unit 160 measures the illumination of a place where the display apparatus 100 is located. The sensor 120 may be a light sensor.

The control unit 160 determines whether to drive the reflective type display panel 213 in consideration of the ambient illumination in step 615. The reflective type display panel 213 has a structure of array of pixel cells. The control unit 160 compares the ambient illumination with at least one preset critical value and thereby determines whether to supply power to each pixel cell of the reflective type display panel 213. Namely, the control unit 160 analyzes data to be displayed and determines at least one data display cell for outputting colors among pixel cells of the reflective type display panel 213 and the other data non-display cell.

Depending on the determination results in step 615, the control unit 160 drives the reflective type display panel 213 in step 617 or does not drive the reflective type display panel 213 in step 619. Here, the control unit 160 controls the supply of power for the reflective type display panel 213, relying on whether to drive the reflective type display panel 213. Namely, the control unit 160 selectively supplies power to the data display cell and the data non-display cell in pixel cells of the reflective type display panel 213. Also, the control unit 160 may supply power with different values varied according to the ambient illumination.

Next, the control unit 160 further determines whether to drive the emissive type display panel 211 in consideration of the ambient illumination in step 621. The emissive type display panel 213 includes an array of pixel cells. The control unit 160 compares the ambient illumination with at least one preset critical value and thereby determines whether to supply power to each pixel cell of the emissive type display panel 211. Namely, the control unit 160 analyzes data to be displayed and determines at least one data display cell for outputting colors among pixel cells of the emissive type display panel 211 and the other data non-display cell.

Depending on the determination results in step 621, the control unit 160 drives the emissive type display panel 211 in step 623 or does not drive the emissive type display panel 211 in step 625. Here, the control unit 160 controls the supply of power for the emissive type display panel 211, relying on whether to drive the emissive type display panel 211. Namely, the control unit 160 selectively supplies power to the data display cell and the data non-display cell in pixel cells of the emissive type display panel 211. Also, the control unit 160 may supply power with varying values according to the ambient illumination.

Next, the control unit 160 transmits display data to at least one of the reflective type display panel 213 and the emissive type display panel 211 in step 627. More specifically, if the reflective type display panel 213 is driven, the control unit 160 transmits display data to the reflective type display panel 213. Similarly, if the emissive type display panel 211 is driven, the control unit 160 transmits display data to the emissive type display panel 211. Otherwise, if both the reflective type display panel 213 and the emissive type display panel 211 are driven, the control unit 160 transmits the same display data to both display panels 213 and 211. Thereafter, the control unit 160 determines whether an image display mode is finished in step 629. If so, the control unit 160 ends the process. Otherwise, the control unit 160 returns to the step 613.

That is, the control unit 160 drives at least one of the emissive type display panel 211 and the reflective type display panel 213 through the driver 220 and the power supply 230. Additionally, the control unit 160 displays data through at least one of the emissive type display panel 211 and the reflective type display panel 213.

Although the control unit 160 determines whether to drive the reflective type display panel 213 and determines whether to drive the emissive type display panel 211, this is exemplary only and it should be understood that it is not limited thereto. Alternatively, the control unit 160 may determine whether to drive the reflective type display panel 213 after determining whether to drive the emissive type display panel 211. Namely, in FIG. 6, steps 615 to 619 may be performed after steps 621 to 625.

Additionally, although the control unit 160 transmits display data to at least one of the display panels 211 and 213 after determining whether to drive the respective display panels 211 and 213, this is exemplary only and it should be understood that it is not limited thereto. Alternatively, the control unit 160 may transmit display data to each of the display panels 211 and 213 simultaneously with driving each display panel. Namely, in FIG. 6, step 627 may be absorbed into each of steps 617 and 623.

Furthermore, although the control unit 160 determines whether to drive each of the display panels 211 and 213 in consideration of the ambient illumination, this is exemplary only and it should be understood that it is not limited thereto. Alternatively, the control unit 160 may not rely on the ambient illumination. For instance, the control unit 160 may determine whether to drive each of the display panels 211 and 213 at a user's request in an image display mode. Therefore, an exemplary embodiment of the present invention may be applied to any display apparatus 100 not having a sensor unit 120.

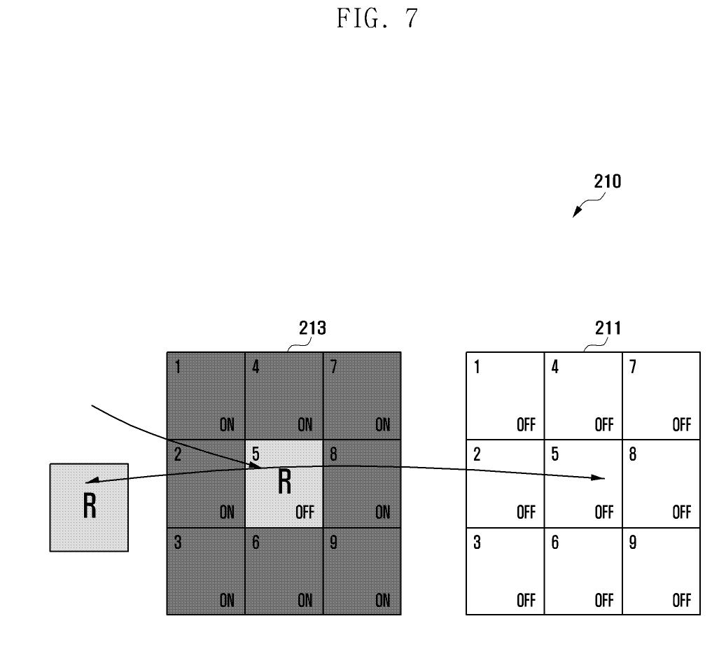

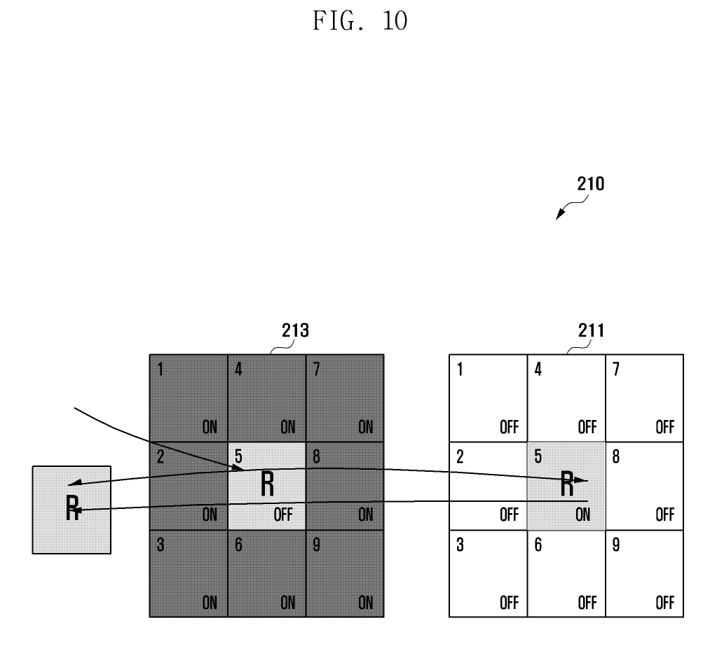

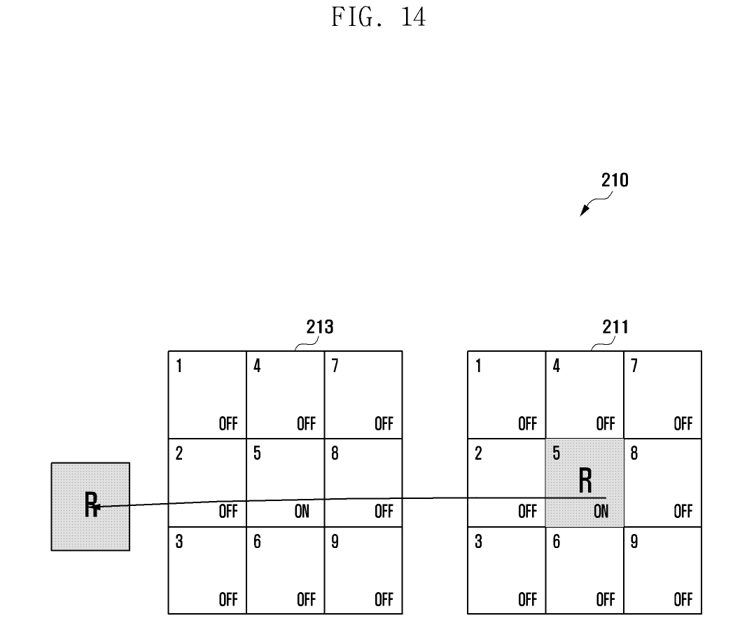

FIGS. 7 to 17 are views illustrating methods for controlling a display panel of a display apparatus in according to exemplary embodiments of the present invention. More specifically, FIGS. 7 to 9 illustrate control methods for the display panel in cases where the ambient illumination around the display apparatus exceeds a first critical value. FIGS. 10 to 13 illustrate control methods for the display panel in cases where the ambient illumination around the display apparatus exceeds a second critical value but does not exceed the first critical value. FIGS. 14 to 17 illustrate control methods for the display panel in cases where the ambient illumination around the display apparatus does not exceed the second critical value. Although examples illustrated in FIGS. 7 to 17 are based on the assumption that the display panel has nine pixel cells respectively indicated by reference numbers 1 to 9, this is exemplary only and it should be understood that it is not limited thereto. Also, the following examples are based on the assumption that the data display cell is to display a red color and the reflective type display panel is formed of CLC. However, this is exemplary only and it should be understood that it is not limited thereto.

Referring to FIG. 7, if the ambient illumination around the display apparatus 100 exceeds the first critical value, the control unit 160 determines the data display cell and the data non-display cell in the reflective type display panel 213. For instance, as illustrated, the control unit 160 may designate a fifth pixel cell of the reflective type display panel 213 as the data display cell and the other pixel cells as the data non-display cell. Additionally, the control unit 160 puts the data display cell of the reflective type display panel 213 in a planar state and the data non-display cell in a homeotropic state. For this, the control unit 160 does not supply power to the data display cell of the reflective type display panel 213, but supplies power to the data non-display cell. More particularly, in order to put the data non-display cell in a homeotropic state, the control unit 160 supplies power with more than a reference value to the data non-display cell. Also, in order to put the data display cell in a planar state, the control unit 160 does not supply power to the data display cell.

Meanwhile, if the ambient illumination around the display apparatus 100 exceeds the first critical value, the control unit 160 does not drive the emissive type display panel 211. Namely, the control unit 160 does not supply power to pixel cells of the emissive type display panel 211.

Therefore, if the ambient illumination around the display apparatus 100 exceeds the first critical value, the reflective type display panel 213 displays data. Namely, the data display cell of the reflective type display panel 213 reflects a red light in an external light. The red light reflected by the reflective type display panel 213 is displayed.

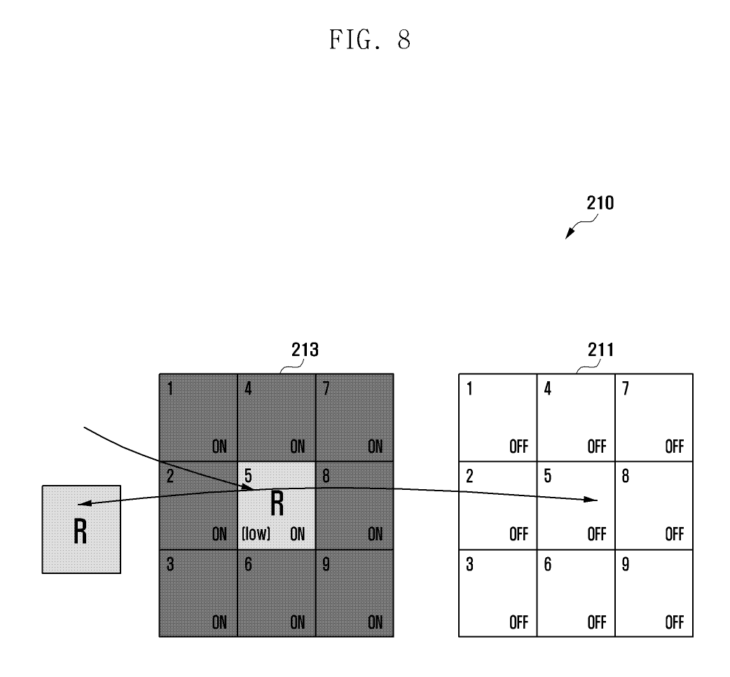

Referring to FIG. 8, if the ambient illumination around the display apparatus 100 exceeds the first critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a focal conic state and the data non-display cell in a homeotropic state. For this, the control unit 160 supplies power with different values to the data display cell and the data non-display cell of the reflective type display panel 213. More particularly, in order to put the data non-display cell in a homeotropic state, the control unit 160 supplies power with more than a reference value to the data non-display cell. Also, in order to put the data display cell in a focal conic state, the control unit 160 supplies power with a reference value or a value less than the reference value to the data display cell.

Meanwhile, if the ambient illumination around the display apparatus 100 exceeds the first critical value, the control unit 160 does not drive the emissive type display panel 211. Namely, the control unit 160 does not supply power to pixel cells of the emissive type display panel 211.

Therefore, if the ambient illumination around the display apparatus 100 exceeds the first critical value, the reflective type display panel 213 displays data. Namely, the data display cell of the reflective type display panel 213 reflects a red light (with lower gradation than a red light in FIG. 7) in an external light. The red light reflected by the reflective type display panel 213 is displayed.

Based on the reflectance of an external light at the reflective type display panel 213 and the output amount of an internal light at the emissive type display panel 211, the control unit 160 allows gradation expression. Namely, by regulating power for the reflective type display panel 213, the control unit 160 may realize various gradation expressions through the reflective type display panel 213. More specifically, by not supplying power to the data display cell of the reflective type display panel 213 as illustrated in FIG. 7, the control unit 160 may express a relatively higher level gradation through the reflective type display panel 213. Also, by supplying power with a reference value or a value less than the reference value to the data display cell of the reflective type display panel 213 as illustrated in FIG. 8, the control unit 160 may express a relatively lower level gradation through the reflective type display panel 213.

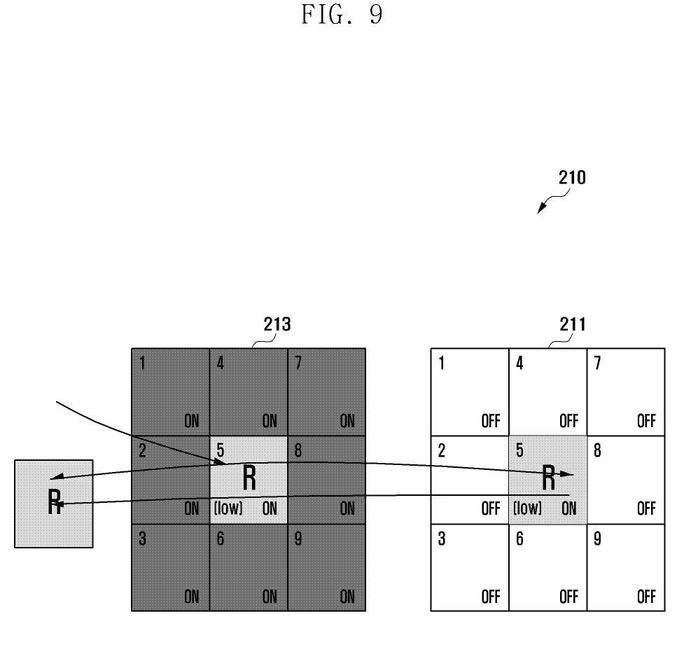

Referring to FIG. 9, if the ambient illumination around the display apparatus 100 exceeds the first critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a focal conic state and the data non-display cell in a homeotropic state. For this, the control unit 160 supplies power with different values to the data display cell and the data non-display cell of the reflective type display panel 213. More particularly, in order to put the data non-display cell in a homeotropic state, the control unit 160 supplies power with more than a reference value to the data non-display cell. Also, in order to put the data display cell in a focal conic state, the control unit 160 supplies power with a reference value or a value less than the reference value to the data display cell.

Meanwhile, if the ambient illumination around the display apparatus 100 exceeds the first critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with a reference value or a value less than the reference value to the data display cell of the emissive type display panel 211.

Therefore, if the ambient illumination around the display apparatus 100 exceeds the first critical value, both the reflective type display panel 213 and the emissive type display panel 211 display data. Namely, the data display cell of the reflective type display panel 213 reflects a red light (with lower gradation than the red light in FIG. 7) in an external light, and the data display cell of the emissive type display panel 211 produces a red light (with lower gradation than the red light in FIG. 7). Both the red light with lower gradation reflected by the reflective type display panel 213 and the red light with lower gradation produced by the emissive type display panel 211 are displayed. Gradation of a red light may be determined by a voltage value supplied with a reference value or a value less than the reference value.

Based on the reflectance of an external light at the reflective type display panel 213 and the output amount of an internal light at the emissive type display panel 211, the control unit 160 allows multiple gradation expression. Namely, by regulating power for the emissive type display panel 211, the control unit 160 may implement various gradation expressions through the emissive type display panel 211. More specifically, by not supplying power to the data display cell of the emissive type display panel 211 as illustrated in FIG. 8, the control unit 160 may express gradation through only the reflective type display panel 213. Also, by supplying power to the data display cell of the emissive type display panel 211 as illustrated in FIG. 9, the control unit 160 may express a relatively higher level gradation through both an external light reflected by the reflective type display panel 213 and an internal light produced by the emissive type display panel 211. Accordingly, the control unit 160 allows multiple gradation expression through both the reflective type display panel 213 and the emissive type display panel 211.

Referring to FIG. 10, if the ambient illumination around the display apparatus 100 exceeds the second critical value but does not exceed the first critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a planar state and the data non-display cell in a homeotropic state. For this, the control unit 160 does not supply power to the data display cell of the reflective type display panel 213 but supplies power to the data non-display cell. More particularly, in order to put the data non-display cell in a homeotropic state, the control unit 160 supplies power with more than a reference value to the data non-display cell. Also, in order to put the data display cell in a planar state, the control unit 160 does not supply power to the data display cell.

Meanwhile, if the ambient illumination around the display apparatus 100 exceeds the second critical value but does not exceed the first critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with more than a reference value to the data display cell of the emissive type display panel 211.

Therefore, if the ambient illumination around the display apparatus 100 exceeds the second critical value but does not exceed the first critical value, both the reflective type display panel 213 and the emissive type display panel 211 display data. Namely, the data display cell of the reflective type display panel 213 reflects a red light in an external light, and the data display cell of the emissive type display panel 211 produces a red light. Both the red light reflected by the reflective type display panel 213 and the red light produced by the emissive type display panel 211 are displayed.

Based on the reflectance of an external light at the reflective type display panel 213 and the output amount of an internal light at the emissive type display panel 211, the control unit 160 allows gradation expression. Namely, by regulating power for each of the reflective type display panel 213 and the emissive type display panel 211, the control unit 160 may implement various gradation expressions through the reflective type display panel 213 and the emissive type display panel 211. More specifically, by supplying power with a reference value or a value less than the reference value to the data display cell of each of the display panels 213 and 211 as illustrated in FIG. 9, the control unit 160 may express a relatively lower level gradation through both the reflective type display panel 213 and the emissive type display panel 211. Also, by not supplying power to the data display cell of the reflective type display panel 213 and supplying power with more than a reference value to the data display cell of the emissive type display panel 211 as illustrated in FIG. 10, the control unit 160 may express a relatively higher level gradation through both the reflective type display panel 213 and the emissive type display panel 211.

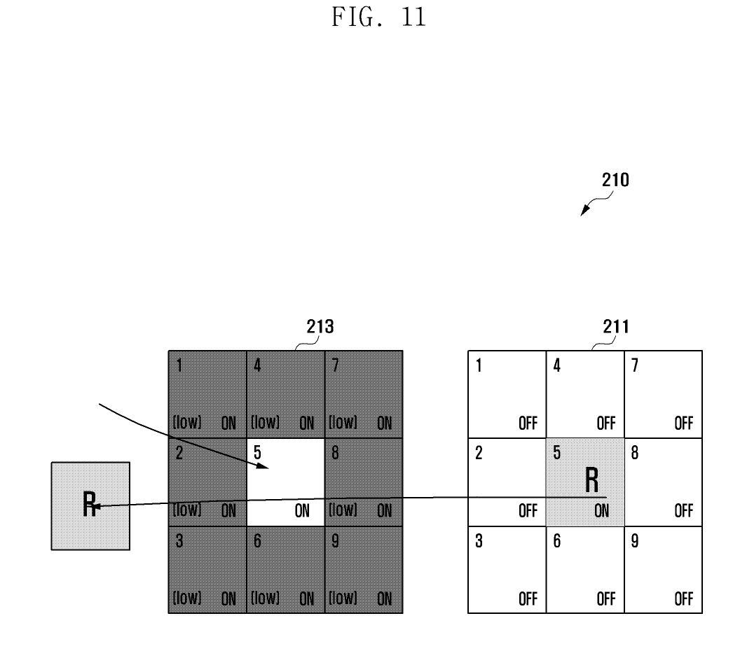

Referring to FIG. 11, if the ambient illumination around the display apparatus 100 exceeds the second critical value but does not exceed the first critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a homeotropic state and the data non-display cell in a focal conic state. For this, the control unit 160 supplies power with different values to the data display cell and the data non-display cell of the reflective type display panel 213. More particularly, in order to put the data non-display cell in a focal conic state, the control unit 160 supplies power with a reference value or a value less than the reference value to the data non-display cell. Also, in order to put the data display cell in a homeotropic state, the control unit 160 supplies power with more than a reference value to the data display cell.

Meanwhile, if the ambient illumination around the display apparatus 100 exceeds the second critical value but does not exceed the first critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with more than the reference value to the data display cell of the emissive type display panel 211.

Therefore, if the ambient illumination around the display apparatus 100 exceeds the second critical value but does not exceed the first critical value, the emissive type display panel 211 displays data. Namely, the data display cell of the reflective type display panel 213 passes an external light, and the data display cell of the emissive type display panel 211 produces a red light. So, a red light produced by the emissive type display panel 211 is displayed.

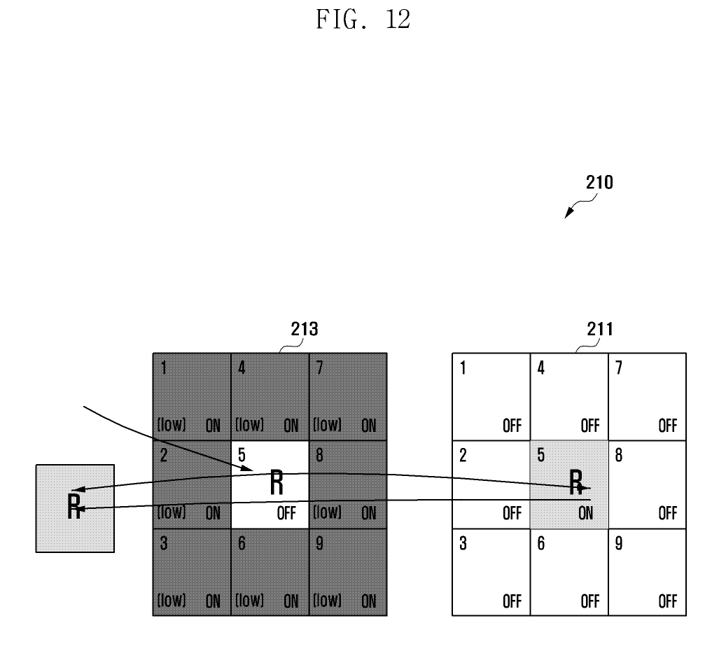

Referring to FIG. 12, if the ambient illumination around the display apparatus 100 exceeds the second critical value but does not exceed the first critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a planar state and the data non-display cell in a focal conic state. For this, the control unit 160 supplies power with different values to the data display cell and the data non-display cell of the reflective type display panel 213. More particularly, in order to put the data non-display cell in a focal conic state, the control unit 160 supplies power with a reference value or a value less than the reference value to the data non-display cell. Also, in order to put the data display cell in a planar state, the control unit 160 does not supply power to the data display cell.

Meanwhile, if the ambient illumination around the display apparatus 100 exceeds the second critical value but does not exceed the first critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with more than a reference value to the data display cell of the emissive type display panel 211.

Therefore, if the ambient illumination around the display apparatus 100 exceeds the second critical value but does not exceed the first critical value, both the reflective type display panel 213 and the emissive type display panel 211 display data. Namely, the data display cell of the reflective type display panel 213 reflects a red light in an external light, and the data display cell of the emissive type display panel 211 produces a red light. Both the red light reflected by the reflective type display panel 213 and the red light produced by the emissive type display panel 211 are displayed. The case of FIG. 12 is effective in reducing power consumption in comparison with the case of FIG. 10 due to a relatively smaller voltage supplied to the data non-display cell of the reflective type display panel 213. Even though the visibility may be dropped in the case of FIG. 12 due to higher reflectance of the data non-display cell in comparison with the case of FIG. 10, the case of FIG. 12 may ensure the visibility of the data display cell because of lower ambient illumination in comparison with the case of FIG. 10.

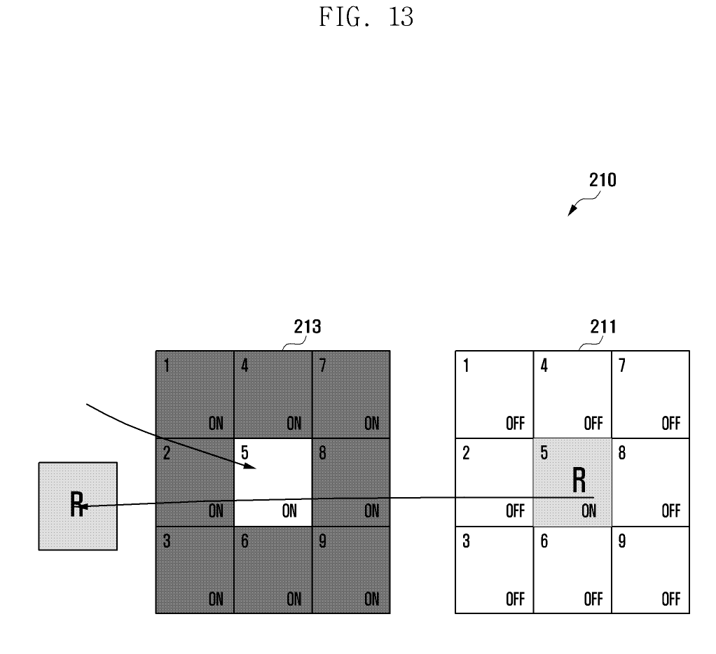

Referring to FIG. 13, if the ambient illumination around the display apparatus 100 exceeds the second critical value but does not exceed the first critical value, the control unit 160 puts the pixel cells of the reflective type display panel 213 in a homeotropic state. For this, the control unit 160 supplies power with more than a reference value to the pixel cells of the reflective type display panel 213.

Meanwhile, if the ambient illumination around the display apparatus 100 exceeds the second critical value but does not exceed the first critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with more than the reference value to the data display cell of the emissive type display panel 211.

Therefore, if the ambient illumination around the display apparatus 100 exceeds the second critical value but does not exceed the first critical value, the emissive type display panel 211 displays data. Namely, the data display cell of the reflective type display panel 213 passes an external light, and the data display cell of the emissive type display panel 211 produces a red light. The red light produced by the emissive type display panel 211 is displayed. In this case, since power is supplied to all the pixel cells of the reflective type display panel 213 and thereby an external light passes through them, it may be possible to reduce the reflection of an external light at the reflective type display panel 213 and further to express colors through the data display cell of the emissive type display panel 211. This case provides improvement on the visibility by reducing the reflection of an external light when the ambient illumination is not mostly high.

Referring to FIG. 14, if the ambient illumination around the display apparatus 100 does not exceed the second critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a homeotropic state and the data non-display cell in a planar state. For this, the control unit 160 supplies power to the data display cell of the reflective type display panel 213 and does not supply power to the data non-display cell. More particularly, in order to put the data non-display cell in a planar state, the control unit 160 does not supply power to the data non-display cell. Also, in order to put the data display cell in a homeotropic state, the control unit 160 supplies power with more than a reference value to the data display cell.

Meanwhile, if the ambient illumination around the display apparatus 100 does not exceed the second critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with more than a reference value to the data display cell of the emissive type display panel 211.

Therefore, if the ambient illumination around the display apparatus 100 does not exceed the second critical value, the emissive type display panel 211 displays data. Namely, the data display cell of the reflective type display panel 213 passes an external light, and the data display cell of the emissive type display panel 211 produces a red light. The red light produced by the emissive type display panel 211 is displayed.

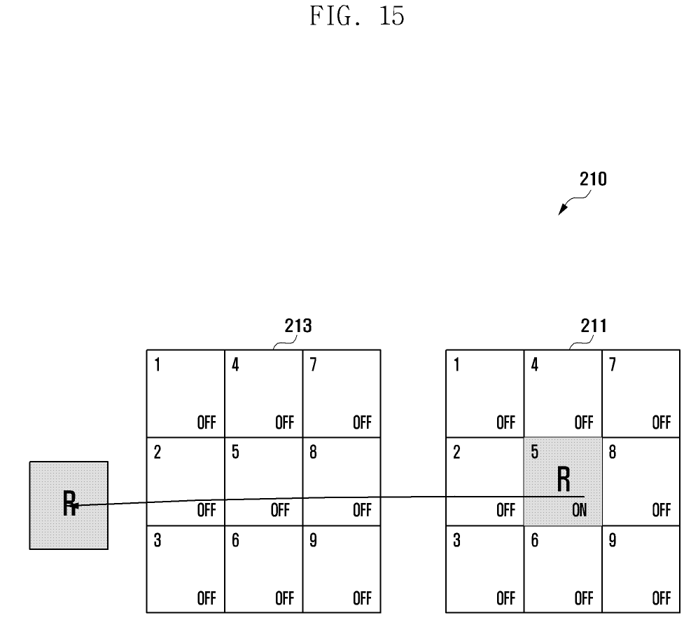

Referring to FIG. 15, if the ambient illumination around the display apparatus 100 does not exceed the second critical value, the control unit 160 puts the pixel cells of the reflective type display panel 213 in a planar state. For this, the control unit 160 does not supply power to the pixel cells of the reflective type display panel 213.

Meanwhile, if the ambient illumination around the display apparatus 100 does not exceed the second critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with more than a reference value to the data display cell of the emissive type display panel 211.

Therefore, if the ambient illumination around the display apparatus 100 does not exceed the second critical value, the emissive type display panel 211 displays data. Namely, the data display cell of the emissive type display panel 211 produces a red light. The red light produced by the emissive type display panel 211 is displayed. In this case, contrary to the case of FIG. 14, the fifth pixel cell of the reflective type display panel 213 reflects an external light. However, since the ambient illumination is smaller than the second critical value, the visibility is reliable in spite of the reflection of external light. Also, this case is effective in reducing power consumption in comparison with the case of FIG. 14 since power is not supplied to the fifth pixel cell.

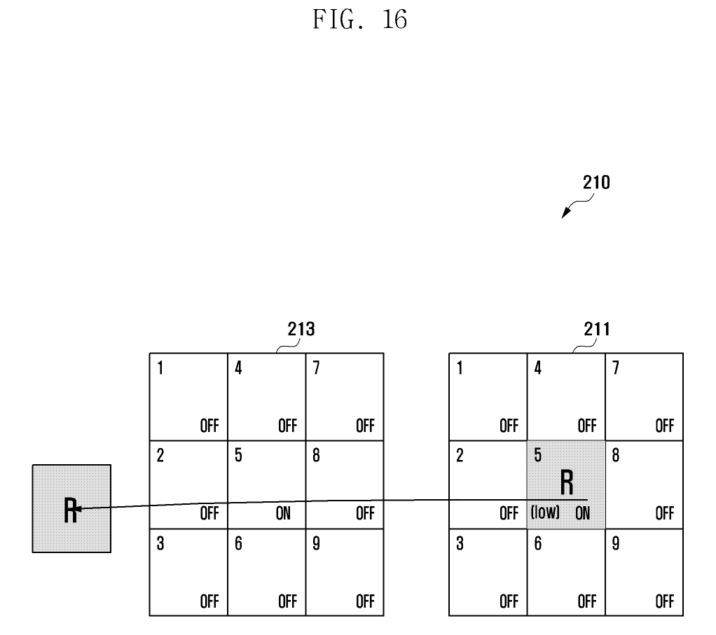

Referring to FIG. 16, if the ambient illumination around the display apparatus 100 does not exceed the second critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a homeotropic state and the data non-display cell in a planar state. For this, the control unit 160 supplies power to the data display cell of the reflective type display panel 213 and does not supply power to the data non-display cell. More particularly, in order to put the data non-display cell in a planar state, the control unit 160 does not supply power to the data non-display cell. Also, in order to put the data display cell in a homeotropic state, the control unit 160 supplies power with more than a reference value to the data display cell.

Meanwhile, if the ambient illumination around the display apparatus 100 does not exceed the second critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with a reference value or a value less than the reference value to the data display cell of the emissive type display panel 211.

Therefore, if the ambient illumination around the display apparatus 100 does not exceed the second critical value, the emissive type display panel 211 displays data. Namely, the data display cell of the reflective type display panel 213 passes an external light, and the data display cell of the emissive type display panel 211 produces a red light with lower gradation than the red light in FIG. 15. The red light with lower gradation produced by the emissive type display panel 211 is displayed. Gradation of the red light may be determined by a voltage value supplied with a reference value or a value less than the reference value.

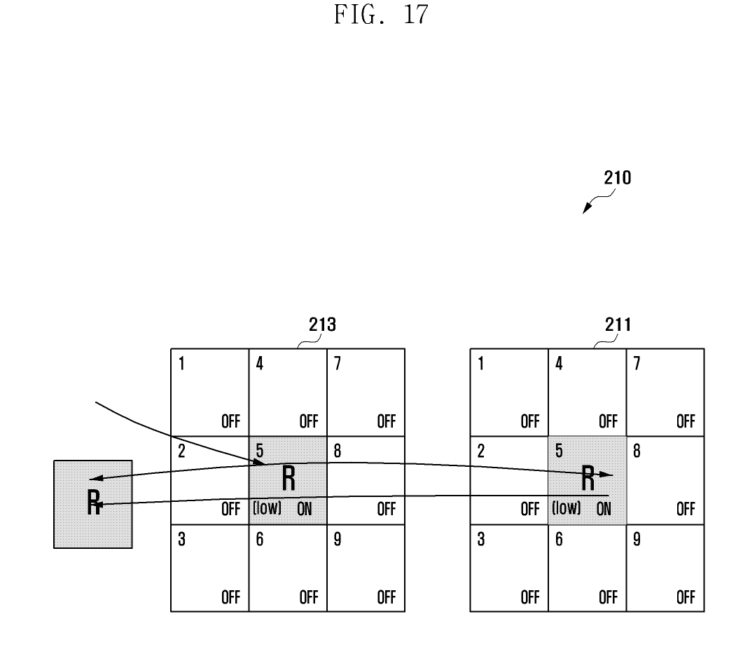

Referring to FIG. 17, if the ambient illumination around the display apparatus 100 does not exceed the second critical value, the control unit 160 determines the data display cell and the data non-display cell in the reflective type display panel 213. For instance, as illustrated, the control unit 160 may designate the fifth pixel cell of the reflective type display panel 213 as the data display cell and the other pixel cells as the data non-display cell. Additionally, the control unit 160 puts the data display cell of the reflective type display panel 213 in a focal conic state and the data non-display cell in a planar state. For this, the control unit 160 supplies power to the data display cell of the reflective type display panel 213 and does not supply power to the data non-display cell. More particularly, in order to put the data non-display cell in a planar state, the control unit 160 does not supply power to the data non-display cell. Also, in order to put the data display cell in a focal conic state, the control unit 160 supplies power with a reference value or a value less than the reference value to the data display cell.

Meanwhile, if the ambient illumination around the display apparatus 100 does not exceed the second critical value, the control unit 160 determines the data display cell and the data non-display cell in the emissive type display panel 211. For instance, as illustrated, the control unit 160 may designate the fifth pixel cell of the emissive type display panel 211 as the data display cell and the other pixel cells as the data non-display cell. The control unit 160 supplies power with a reference value or a value less than the reference value to the data display cell of the emissive type display panel 211.

Therefore, if the ambient illumination around the display apparatus 100 does not exceed the second critical value, the emissive type display panel 211 displays data. Namely, the data display cell of the reflective type display panel 213 reflects a red light with lower gradation, and the data display cell of the emissive type display panel 211 produces a red light with lower gradation. Both the red light with lower gradation reflected by the reflective type display panel 213 and the red light with lower gradation produced by the emissive type display panel 211 are displayed. Gradation of the red light may be determined by a voltage value supplied with a reference value or a value less than the reference value.

Based on the reflectance of an external light at the reflective type display panel 213 and the output amount of an internal light at the emissive type display panel 211, the control unit 160 allows multiple gradation expression. Meanwhile, the reflection of external light is not intense when the ambient illumination does not exceed the second critical value. Therefore, by regulating power for the emissive type display panel 211, the control unit 160 may realize various gradation expressions through the emissive type display panel 211.

Although the control unit 160 controls the display panel 210 by comparing the ambient illumination with two critical values, this is exemplary only and it should be understood that it is not limited thereto. In an exemplary implementation, the control unit 160 may control the display panel 210 by comparing the ambient illumination with a single critical value. Namely, the control unit 160 may determine whether the ambient illumination exceeds a single critical value, and control the display panel 210. In another exemplary implementation, the control unit 160 may compare the ambient illumination with three critical values and thereby control the display panel 210.

Additionally, although the control unit 160 determines whether to drive each of the reflective type display panel 213 and the emissive type display panel 211 based on the ambient illumination, this is exemplary only and it should be understood that it is not limited thereto. Alternatively, the control unit 160 may not rely on the ambient illumination. For instance, the control unit 160 may determine whether to drive each of the display panels 211 and 213 at a user's request in an image display mode. Therefore, an exemplary embodiment of the present invention may be applied to any display apparatus 100 not having a sensor unit 120.

Furthermore, although the emissive type display panel 211 may be formed of an OLED, this is exemplary only and it should be understood that it is not limited thereto. Alternatively, the emissive type display panel 211 may be formed of a Liquid Crystal Display (LCD) panel. In this case, the display apparatus 100 further includes a backlight for offering an internal light to the emissive type display panel 211.

According to an exemplary embodiment of the present invention, the display panel 210 may reflect a left-circular polarized red light in a white light such that the reflected red light may be displayed. Also, the display panel 210 may prevent the white light, except a left-circular polarized red light, from being displayed. Namely, the display panel 210 can express a particular color by reflecting an external incident light at the reflective type display panel 213. This allows a user of the display apparatus 100 to perceive an image through the reflective type display panel 213 at any place with a relatively higher ambient illumination, e.g., outdoors in the daytime, without any secondary light source.

Additionally, the display panel 210 may produce a right-circular polarized red light such that the produced red light may be displayed. Namely, the display panel 210 can express a particular color by producing an internal light at the emissive type display panel 211. This allows a user of the display apparatus 100 to perceive an image through the emissive type display panel 211 at any place with a relatively lower ambient illumination, e.g., outdoors at nighttime or indoors, without any secondary light source or external light.

Accordingly, the display apparatus 100 according to an exemplary embodiment of the present invention allows a user to perceive an image regardless of ambient illumination. Namely, the display apparatus 100 may achieve a regular and reliable quality of display regardless of its location. Also, the display apparatus 100 may improve the visibility of data displayed thereon.

Furthermore, the display apparatus 100 separately controls the data display cell and the data non-display cell in the display panel 210, so a contrast ratio between the data display cell and the data non-display cell may be improved. More particularly, since the intermediate film layer 212 prevents an external light passing through the reflective type display panel 213 from being reflected to the outside, the contrast ratio between the data display cell and the data non-display cell in the reflective type display panel 213 may be improved. Therefore, the display apparatus 100 may improve the visibility of data displayed thereon. Also, the display apparatus 100 may implement various gradation expressions by regulating power supplied to the display panel 210.

While the invention has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A hybrid display apparatus, the apparatus comprising:
an emissive type display panel for outputting an internal light to the outside and for displaying data;
a reflective type display panel for passing the internal light to the outside, for reflecting an external light, and for displaying the data; and
an intermediate film layer interposed between the emissive type display panel and the reflective type display panel, and for passing the internal light from the emissive type display panel to the reflective type display panel and for blocking the external light that passes through the reflective type display panel and is reflected at the emissive type display panel.

2. The apparatus of claim 1, wherein the intermediate film layer passes the external light toward the emissive type display panel when the external light falls thereon through the reflective type display panel, absorbs or blocks the external light when the external light falls thereon after reflected at the emissive type display panel, and passes the internal light toward the reflective type display panel when the internal light falls thereon through the emissive type display panel.

3. The apparatus of claim 2, wherein the intermediate film layer comprises:
a first phase delay film for converting a first circular polarized light of the external light into a first linear polarized light when the external light falls thereon through the reflective type display panel;
a polarizer film comprising a polarization axis for passing the first linear polarized light; and
a second phase delay film for converting the first linear polarized light into a second circular polarized light being different from the first circular polarized light in a rotation direction and for passing the second circular polarized light toward the emissive type display panel.

4. The apparatus of claim 3, wherein when the second circular polarized light is reflected at the emissive type display panel to a third circular polarized light being equal to the first circular polarized light in the rotation direction and falls on the second phase delay film, the second phase delay film converts the third circular polarized light into a second linear polarized light including an optic axis being different from an optic axis of the polarizer film in angle such that the third circular polarized light does not pass through the polarizer film.

5. The apparatus of claim 1, further comprising:
a control unit for determining at least one of a data display cell for outputting the data among pixel cells of each of the emissive type display panel and the reflective type display panel and another data non-display cell among the pixel cells, and for controlling to supply electric power to the data display cell and the data non-display cell.

6. The apparatus of claim 5, further comprising:
a sensor for detecting an ambient illumination such that the control unit determines the data display cell and the data non-display cell in each of the emissive type display panel and the reflective type display panel in consideration of the ambient illumination.

7. The apparatus of claim 5, further comprising:
an input unit for receiving a user's request such that the control unit determines the data display cell and the data non-display cell in each of the emissive type display panel and the reflective type display panel in consideration of the user's request.

8. The apparatus of claim 6, wherein the control unit controls, when the ambient illumination exceeds a preset critical value, the data display cell of the reflective type display panel to reflect the external light, the data non-display cell of the reflective type display panel to pass the external light, and the emissive type display panel not to output the internal light, and
wherein the control unit controls, when the ambient illumination does not exceed the preset critical value, the data display cell of the emissive type display panel to output the internal light, and the reflective type display panel to pass the internal light to the outside.

9. The apparatus of claim 5, wherein the control unit allows gradation expression based on both the reflectance of the external light at the reflective type display panel and the output amount of the internal light at the emissive type display panel.

10. The apparatus of claim 1, wherein the reflective type display panel comprises a liquid crystal layer formed of cholesteric liquid crystal that is changed to one of a planar state, a focal conic state, and a homeotropic state according to the strength of an electric field applied thereto.

11. A display method of a hybrid display apparatus, the method comprising:
determining whether to drive each of an emissive type display panel and a reflective type display panel; and
displaying the data with an image and color by driving at least one of the emissive type display panel and the reflective type display panel,
wherein the hybrid display apparatus comprises the emissive type display panel for outputting an internal light to the outside and for displaying data, the reflective type display panel for passing the internal light to the outside, for reflecting an external light, and for displaying the data, and an intermediate film layer, interposed between the emissive type display panel and the reflective type display panel, for passing the internal light from the emissive type display panel to the reflective type display panel and for blocking the external light that passes through the reflective type display panel and reflected at the emissive type display panel.

12. The method of claim 11, wherein the intermediate film layer passes the external light toward the emissive type display panel when the external light falls thereon through the reflective type display panel, absorbs or blocks the external light when the external light falls thereon after reflected at the emissive type display panel, and passes the internal light toward the reflective type display panel when the internal light falls thereon through the emissive type display panel.

13. The method of claim 12, wherein the intermediate film layer comprises:
a first phase delay film for converting a first circular polarized light of the external light into a first linear polarized light when the external light falls thereon through the reflective type display panel;
a polarizer film comprising a polarization axis for passing the first linear polarized light; and
a second phase delay film for converting the first linear polarized light into a second circular polarized light being different from the first circular polarized light in a rotation direction and for passing the second circular polarized light toward the emissive type display panel.

14. The method of claim 13, wherein when the second circular polarized light is reflected at the emissive type display panel to a third circular polarized light being equal to the first circular polarized light in the rotation direction and falls on the second phase delay film, the second phase delay film converts the third circular polarized light into a second linear polarized light including an optic axis being different from an optic axis of the polarizer film in angle such that the third circular polarized light may not pass through the polarizer film.

15. The method of claim 11, wherein the displaying of the data comprises:
performing gradation expression of the color by passing the external light through at least one data display cell for outputting the data among pixel cells of the reflective type display panel and by regulating penetration and reflection of the external light;
performing gradation expression of the color by outputting the internal light from at least one data display cell for outputting the data among pixel cells of the emissive type display panel, by not outputting the internal light from the other data non-display cell among the pixel cells, and by regulating output of the internal light; and
performing multiple gradation expression of the color by regulating the penetration and reflection of the external light in the reflective type display panel and by regulating the output of the internal light in the emissive type display panel.

16. The method of claim 15, wherein the determining whether to drive each display panel comprises:
determining whether to supply power and a quantity of power such that each pixel cell of the reflective type display panel reflects the external light to display the data, passes the external light in order not to display the data, or regulates the reflection of the external light; and
determining whether to supply power a quantity of power such that each pixel cell of the emissive type display panel outputs the internal light to display the data, does not output the internal light in order not to display the data, or regulates the output of the internal light.

17. The method of claim 16, wherein the determining of whether to drive each display panel comprises:
with regard to each pixel cell of the reflective type display panel, determining whether not to supply power in order to reflect the external light, to supply the power in order to pass the external light, and to regulate the supply quantity of power according to penetration and reflection of the external light;
with regard to each pixel cell of the emissive type display panel, determining whether to supply power in order to output the internal light, not to supply the power in order not to output the internal light, and to regulate the supply quantity of power according to output of the internal light; and
with regard to each pixel cell of the reflective type display panel and the emissive type display panel, determining whether to perform multiple gradation expression of the color by regulating the penetration and reflection of the external light in the reflective type display panel and by regulating the output of the internal light in the emissive type display panel.

18. The method of claim 11, wherein the determining of whether to drive each display panel comprises:
when the ambient illumination exceeds a preset critical value, determining whether to display the data through the reflective type display panel by determining that at least one data display cell for outputting the data among pixel cells of the reflective type display panel reflects the external light, that the other data non-display cell among the pixel cells passes the external light, and that the emissive type display panel does not output the internal light; and
when the ambient illumination does not exceed the preset critical value, determining whether to display the data through the emissive type display panel by determining that at least one data display cell for outputting the data among pixel cells of the emissive type display panel outputs the internal light, and that the reflective type display panel passes the internal light to the outside.

19. The method of claim 11, wherein the determining of whether to drive each display panel comprises:
in response to a user's request, determining whether to display the data through the reflective type display panel by determining that at least one data display cell for outputting the data among pixel cells of the reflective type display panel reflects the external light, that the other data non-display cell among the pixel cells passes the external light, and that the emissive type display panel does not output the internal light; and
in response to a user's request, determining whether to display the data through the emissive type display panel by determining that at least one data display cell for outputting the data among pixel cells of the emissive type display panel outputs the internal light, and that the reflective type display panel passes the internal light to the outside.

20. The method of claim 11, wherein the reflective type display panel comprises a liquid crystal layer formed of cholesteric liquid crystal that is changed to one of a planar state, a focal conic state, and a homeotropic state according to the strength of an electric field applied thereto.
